(19) United States
(12) Patent Application Publication
(10) Pub. No.: US 2026/0260645 A1
(43) Pub. Date: Sep. 3, 2026

(54) SOUND SYNTHESIS SYSTEM USING MULTIPLE INTERACTIVE DEVICES

(71) Applicant: HARMAN INTERNATIONAL INDUSTRIES, INCORPORATED, Stamford, CT (US)

(72) Inventors: Kevin J. BASTYR, Franklin, MI (US); Srinath ARUNACHALAM, Dallas, TX (US); Kadagattur Gopinatha SRINIDHI, Novi, MI (US)

(21) Appl. No.: 19/489,152

(22) PCT Filed: Jun. 23, 2023
(86) PCT No.: PCT/US2023/026152

§ 371 Date: Dec. 1, 2025

(51) Int. Cl. G10K 15/04; A63H 5/00; G06F 3/16

(52) U.S. Cl. CPC G10K 15/04; G06F 3/165; A63H 5/00; A63H 2200/00

(57) ABSTRACT

Various embodiments disclose a computer-implemented method comprising generating, based on a signal flow, an audio synthesis configuration including at least one audio object to synthesize an audio signal, retrieving a synthesis characteristic profile acquired from an external device, the synthesis characteristic profile indicating one or more respective characteristic values for one or more synthesis characteristics, identifying one or more synthesis parameter settings based on the one or more respective characteristic values, modifying the audio synthesis configuration based on the identified one or more synthesis parameter settings to generate a modified audio synthesis configuration, synthesizing an audio signal based on the modified audio synthesis configuration, and outputting, using an audio output device, an audio reproduction of the audio signal.

### BACKGROUND

### Field of the Various Embodiments

The various embodiments relate generally to sound synthesis systems and, more specifically, to a sound synthesis system using multiple interactive devices.

### Description of the Related Art

Various consumer devices output sound to enhance the user experience when interacting with the consumer device. For example, various products produce sound to entertain users. In such products, a sound-producing circuit stores a pre-recorded sound file. When the product receives an input, such as a button press, the sound-producing circuit loads the pre-recorded sound file and drives a speaker to output an audio reproduction of the sound file.

At least one drawback of conventional sound producing devices is that such devices have limited ability to play multiple sounds. For example, pre-recorded sounds require a large amount of storage space, requiring sound producing devices that play a large number of sounds to include large amounts of storage, limiting the range of devices that can be used to produce all of these sounds. Some devices use low-power microcontrollers or storage systems to minimize costs; however, the limited storage and processing capacity of such systems limits the device to reproducing sound from only a limited number of stored audio files. In addition, conventional sound producing devices are not able to alter the output of the pre-recorded sounds other than in simple ways, such as by mixing two sounds to form the simple sum of the original sounds, resulting in the device essentially reproducing the same sounds simultaneously, which detracts from versatility and the long-term entertainment value of the device.

In light of the above, more effective techniques to store and generate a range of sound outputs in consumer devices, including multiple interactive devices, would be useful.

### SUMMARY

Various embodiments disclose a computer-implemented method comprising generating, based on a signal flow, an audio synthesis configuration including at least one audio object to synthesize an audio signal, retrieving a synthesis characteristic profile acquired from an external device, the synthesis characteristic profile indicating one or more respective characteristic values for one or more synthesis characteristics, identifying one or more synthesis parameter settings based on the one or more respective characteristic values, modifying the audio synthesis configuration based on the identified one or more synthesis parameter settings to generate a modified audio synthesis configuration, synthesizing an audio signal based on the modified audio synthesis configuration, and outputting, using an audio output device, an audio reproduction of the audio signal.

Further embodiments provide, among other things, non-transitory computer-readable storage media storing instructions for implementing the method set forth above, as well as an interactive toy, a device, and a system configured to implement the method set forth above.

At least one technological advantage of the sound synthesis application relative to the prior art is that, with the disclosed techniques, the sound synthesis application can generate a large variety of sounds in real time using a small microprocessor and memory. Another advantage is that the sound synthesis application is able to alter the generated sound based on sound synthesis parameters attributed to nearby devices and customizing the sound output based on the presence of nearby devices. Generating sounds based on the presence of nearby devices enables the sound synthesis application to generate multiple sound outputs or non-repetitive sound outputs with a wide range of characteristics using a limited library of data stored in the memory. Such techniques increase the variety of sounds that the device can produce, increasing the usefulness of the device producing the synthesized sounds. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a conceptual block diagram of a sound synthesis system configured to implement one or more aspects of the present disclosure;

FIG. 2 illustrates a block diagram of an exemplary signal flow executed by the sound synthesis system of FIG. 1, according to various embodiments of the present disclosure;

FIG. 3 illustrates a plurality of characteristic tables used by the sound synthesis system of FIG. 1 to generate a composite audio synthesis configuration, according to various embodiments of the present disclosure;

FIG. 4 illustrates a block diagram of the sound synthesis application of FIG. 1 generating a synthesized audio signal based on a composite audio synthesis configuration using a synthesis characteristic profile acquired from a proximate external device, according to various embodiments of the present disclosure; and

FIG. 5 sets forth a flow diagram of method steps for synthesizing an audio signal for output by an audio output device, according to various embodiments of the present disclosure.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### Overview

Embodiments disclosed herein include a sound synthesis system that includes a client computing device that synthesizes an audio signal for reproduction by an audio output device. A sound synthesis application executing on the client computing device loads from memory an audio synthesis configuration. The audio synthesis configuration includes tuning parameters, a signal flow that specifies a set of audio objects, and/or control signal values that, in conjunction, synthesize an audio signal. The audio synthesis configuration specifies which audio objects from a library of predefined audio objects are to be used and specifies one or more synthesis parameter values, which modify how the respective audio objects operate. One or more of the synthesis parameter settings are specified by one or more synthesis characteristic profiles associated with an external device. Based on the audio synthesis configuration, the client computing device configures the arrangement of one or more audio objects and connections between the audio objects in the manner specified in the signal flow. The sound synthesis application uses the configured audio objects and the one or more synthesis characteristic profiles to synthesize the audio signal in real time.

In various embodiments, the client computing device receives synthesis characteristic settings from the external devices proximate to the client computing device. In such instances, the sound synthesis application augments synthesis characteristic settings associated with the audio synthesis configuration by incorporating the synthesis characteristic settings acquired from the synthesis characteristic profiles included in the nearby external devices to generate a synthesized audio signal that is based on a combination of the synthesis characteristic settings, thereby modifying the synthesized audio signal generated by the audio synthesis configuration.

For example, the client computing device acquires a synthesis characteristic profile from a nearby external device. The sound synthesis application loads, from an internal characteristic table, an audio synthesis configuration that includes an initial set of synthesis characteristic values specifying synthesis parameter settings for a set of synthesis characteristics. An “energetic” characteristic value for an energy synthesis characteristic modifies the gain values of an audio signal produced by a waveform generator, and an “enraged” characteristic value for a mood synthesis characteristic modifies filter coefficients employed by a filter. The sound synthesis application can then receive a synthesis characteristic profile from a nearby external device that includes a “fierce” characteristic value for use by the audio synthesis configuration in lieu of the energetic characteristic value. The sound synthesis application generates a composite audio synthesis configuration that replaces for the energy synthesis characteristics the energetic characteristic value with the fierce characteristic value, thereby modifying the gain to different value, changing the synthesized audio signal produced. In this way, the sound synthesis application generates interactive sounds based on numerous combinations of characteristic values associated with multiple external devices and provides a way for the client computing device to continually change in real-time the character of the audio output that is produced.

The sound synthesis system can be implemented in various forms, such as an interactive device including a processor and local memory, personal computers, and so forth. For example, the sound synthesis system can be incorporated in one or more interactive toys (e.g., a bird toy or monster including a voice box). Additionally or alternatively, in some embodiments, the sound synthesis system can be incorporated into other types of non-toy consumer devices. The sound synthesis system can perform the processing functions using a dedicated processing device and/or a separate computing device, such as a mobile computing device of a user or a cloud computing system. The sound synthesis system can detect various environmental values using any number of sensors of various types, which can be attached to, integrated with other system components, or disposed separately.

### System Overview

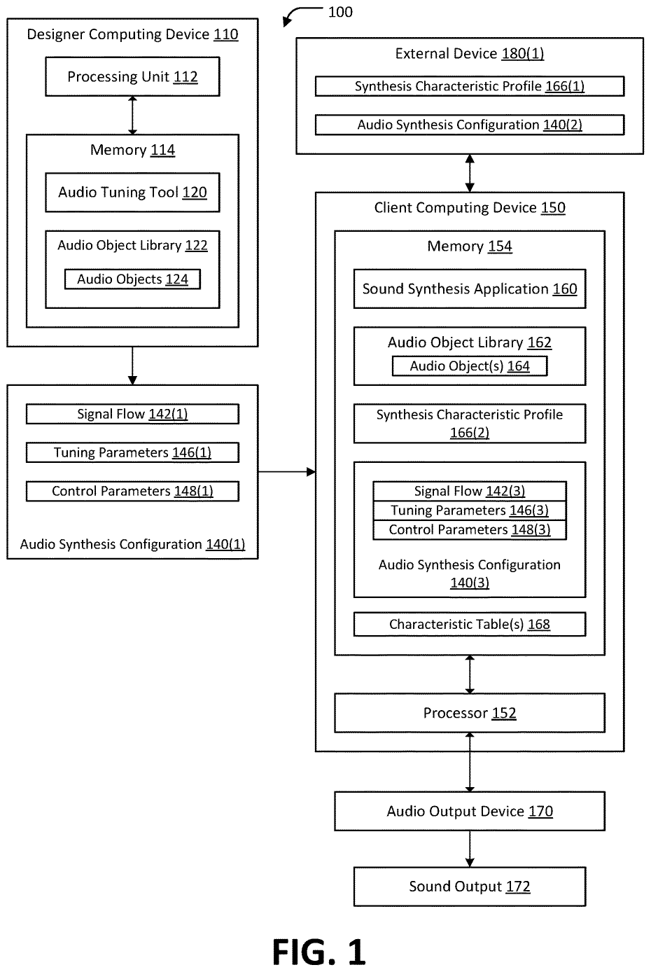

FIG. 1 illustrates a conceptual block diagram of a sound synthesis system 100 configured to implement one or more aspects of the present disclosure. As shown, the sound synthesis system 100 includes, without limitation, a designer computing device 110, one or more audio synthesis configurations 140 (e.g., 140(1)), a client computing device 150, an audio output device 170, and one or more external devices 180 (e.g., 180(1), etc.). The designer computing device 110 includes, without limitation, a processing unit 112 and a memory 114. The memory 114 includes, without limitation, an audio tuning tool 120 and an audio object library 122 including one or more audio objects 124. The client computing device 150 includes, without limitation, a processor 152 and a memory 154. The memory 154 includes, without limitation, a sound synthesis application 160, one or more audio synthesis configurations 140 (e.g., 140(3)), an audio object library 162 including one or more audio objects 164, and one or more characteristic tables 168. The one or more external devices 180 include, without limitation, one or more synthesis characteristic profiles 166 (e.g., 166(1)) and one or more audio synthesis configurations 140 (e.g., 140(2)).

In operation, the audio tuning tool 120 executing on the designer computing device 110 accesses the audio object library 122 to generate an audio synthesis configuration 140. For example, a designer can use the audio object library 122 to specify which audio objects 124 from the audio object library 122, parameters from characteristic table 168, and/or values from a synthesis characteristic profile 166 to use when generating sounds. The audio synthesis configuration 140(1) includes a set of tuning parameters 146(1), a set of control parameters 148(1), and a signal flow 142(1) providing a configuration of one or more audio objects that are in the audio object library 122 and associated parameters to be retrieved from the characteristic table 168 and/or a synthesis characteristic profile 166. The audio synthesis configuration, upon activation, generates a synthesized audio signal. The synthesis characteristic values are associated with specific synthesis parameter settings (e.g., values for the set of tuning parameters 146(1) and/or the set of control parameters 148(1)) that control the audio objects in the audio synthesis configuration 140(1).

The designer computing device 110 transmits the audio synthesis configuration 140(1) to the client computing device 150 for storage as one of a group of locally stored audio synthesis configurations 140 (e.g., the audio synthesis configuration 140(3)). The sound synthesis application 160 executing on the client computing device 150 generates a synthesized audio signal based on one of the stored audio synthesis configurations 140(3). When synthesizing an audio signal for output, the sound synthesis application 160 selects an audio synthesis configuration from the set of stored audio synthesis configurations 140(3). The selected audio synthesis configuration specifies one or more audio objects defined in the audio object library 162 and connections between the audio objects.

The sound synthesis application 160 configures the local audio objects 164 in an arrangement corresponding to the selected audio synthesis configuration 140(3) (e.g., the signal flow 142(3), the tuning parameters 146(3), and the control parameters 148(3)), where the sound synthesis application 160 generates the arrangement as specified by the signal flow 142(3) and uses synthesis parameters as modified by the tuning parameters 146(3) and/or the control parameters 148(3). For example, the sound synthesis application 160 can be an extendable audio framework (xAF) application produced by Harman International® In various embodiments, the sound synthesis application 160 acquires a synthesis characteristic profile 166 (e.g., 166(1)) and/or audio synthesis configurations 140 (e.g., 140(2)) from an external device 180 (e.g., the external device 180(1)) that is proximate to the client computing device 150 and stores the acquired profile locally (e.g., the synthesis characteristic profile 166(2)). The sound synthesis application 160 augments the selected audio synthesis configuration 140(3) by replacing the one or more synthesis characteristic values included in the selected audio synthesis configuration 140(3) with one or more synthesis characteristic values from the synthesis characteristic profile 166(3) of a proximate second external device 180(3), thereby modifying the synthesis characteristic profile 166(2) to generate a composite audio synthesis configuration 140. The composite audio synthesis configuration 140 includes different synthesis characteristic values than those included in the selected audio synthesis configuration 140(3). The sound synthesis application 160 updates the arrangement of audio objects 164 and connections using the synthesis characteristic values from the composite audio synthesis configuration, causing the updated and/or modified arrangement to produce a synthesized audio signal. The sound synthesis application 160 drives the audio output device 170 to provide a sound output 172 that is a reproduction of the synthesized audio signal. In this manner, the sound synthesis system 100 synthesizes an audio signal that includes combinations or a blending of both an audio signal the sound synthesis application 160 would synthesize by loading the audio synthesis configuration 140(3) and an audio signal the sound synthesis application 160 would synthesize by loading the synthesis characteristic profile 166(2) of the external device 180(3).

Designer computing device 110 is a computing device that a designer uses to generate an audio synthesis configuration 140(1). In various embodiments, the designer computing device 110 communicates with the client computing device 150 directly or via a network (not shown) to update the client computing device 150 with the sound synthesis application 160, the audio object library 162 (e.g., a copy of or a subset of the audio object library 122), and/or the audio synthesis configuration 140.

The processing unit 112 can be any suitable processor, such as a central processing unit (CPU), a graphics processing unit (GPU), an application-specific integrated circuit (ASIC), a field programmable gate array (FPGA), a digital signal processor (DSP), and/or any other type of processing unit, or a combination of different processing units, such as a system on a chip (SoC), or a CPU configured to operate in conjunction with a GPU. In general, the processing unit 112 can be any technically feasible hardware unit capable of processing data and/or executing software applications.

The memory 114 can include a random-access memory (RAM) module, a flash memory unit, or any other type of memory unit or combination thereof. The processing unit 112 is configured to read data from and write data to the memory 114. In various embodiments, the memory 114 includes non-volatile memory, such as optical drives, magnetic drives, flash drives, electrically erasable programmable read-only memory (EEPROM) or other storage. In some embodiments, separate data stores, such as external data stores included in a network (“cloud storage”) can supplement or constitute the memory 114. In some embodiments, the audio tuning tool 120 within the memory 114 can be executed by the processing unit 112 to implement the overall functionality of the designer computing device 110. In various embodiments, an interconnect bus (not shown) connects the processing unit 112, the memory 114, and any other components of the designer computing device 110.

The audio tuning tool 120 generates one or more audio synthesis configurations 140 (e.g., the audio synthesis configuration 140(1)), where a given audio synthesis configuration 140 specifies how a computing device (e.g., the designer computing device 110, the client computing device 150, external devices 180, etc.) is to synthesize an audio signal for playback using a set of predefined audio objects and synthesis parameters. In various embodiments, the designer computing device 110 uses the audio tuning tool 120 to generate an audio synthesis configuration and simulate the operation of the client computing device 150 and/or the sensors 190 to simulate the reproduction of the sound output 172 based on the generated audio synthesis configuration. For example, the audio tuning tool 120 can be a graphical user interface, such as the Global Tuning Tool (GTT) produced by Harman International, that enables users to visually load predefined audio objects and add connections between the audio objects and configure tuning parameters.

In various embodiments, the audio tuning tool 120 enables a designer to modify synthesis parameters used by the predefined audio objects when synthesizing a sound. For example, the audio tuning tool 120 can load a waveform generator from the audio object library 122 and can modify the synthesis parameters (e.g., amplitude, frequency, waveform type, phase, etc.) employed by the waveform generator when synthesizing a waveform. In some embodiments, the audio tuning tool includes one or more characteristic tables mapping specific synthesis characteristic values of a given synthesis characteristic to specific synthesis parameter settings. In such instances, the audio tuning tool 120 can include the synthesis characteristic values in the audio synthesis configuration 140. Additionally or alternatively, the audio tuning tool 120 can generate a synthesis characteristic profile 166 that includes a set of synthesis characteristic values. For example, the audio tuning tool 120 can retrieve a “seriousness” characteristic table that maps a discrete set of descriptors of the seriousness synthesis characteristic (e.g., zany, hilarious, silly, goofy, neutral, serious, etc.), to the specific frequencies that the waveform generator produces. In such instances, the designer can generate an audio synthesis configuration 140 that includes a specific seriousness characteristic value, where the sound synthesis application specifies the frequency value corresponding to the seriousness characteristic value as the frequency value the waveform generator is to produce.

The audio object library 122 includes predefined audio objects that act as sound synthesis blocks that can be combined to generate a sound. For example, the audio object library 122 defines the functionalities of various audio objects including pink and white noise generators, waveform generators (oscillators, triangle wave generators, etc.), amplitude controls (e.g., gain, volume, mute, limiter and envelope), mixers to combine signals, control signal mixers, routers, scalers, splitters and selectors, control signal modulators, control signal generators, control signal tables, distortion effects, delay elements, music file players, lookup tables (LUTs), frequency equalization blocks, and filters, including high-pass filters (HPF), low-pass filters (LPF), bandpass filters (BP), shelf filters, biquads, finite impulse response (FIR) filters, and so forth. These various audio objects are embodied in lines of code that, when executed, process, generate, filter or otherwise create and/or modify the audio or control signals using their accompanying tuning parameters and control signals as inputs. In various embodiments, the audio tuning tool 120 displays the audio objects from the audio library for use in generating an audio synthesis configuration (e.g., the audio synthesis configuration 140(1)).

The audio synthesis configuration 140 (e.g., the audio synthesis configurations 140(1), 140(2), 140(3), etc.) includes one or more files that specify the arrangement of audio objects (e.g., a listing of audio objects and interconnections) and synthesis parameters required to synthesize an audio signal. The audio synthesis configuration 140 specifies a subset of audio objects from an audio object library 122 via a signal flow 142, which also specifies the interconnections between the audio objects. The audio synthesis configuration 140 also specifies synthesis parameters (e.g., control parameters 148, tuning parameters 146, and/or inputs from sensor data values 192) that the specified arrangement is to use to generate a specific sound. In various embodiments, the audio synthesis configuration 140 includes a number of synthesis parameters that configure the audio objects. For example, the audio synthesis configuration 140(1) includes, in addition to the signal flow 142(1), a set of tuning parameters 146(1) that includes, among other things, gain values, frequencies, envelope parameters such as amplitude-vs-time values, frequency modulation parameters, filter coefficients, filter corner frequencies, Qs and gains, limiter profiles, distortion coefficients, length of delay (in ms or s), and/or lookup tables. In another example, the audio synthesis configuration 140(1) includes a set of control parameters 148(1), such as “enable,” “disable,” or “mute” controls that control the functionality of individual objects, table index values to select which table of tuning parameters associated with an audio object are selected as “active,” “loop,” or “one-shot,” to determine an operating state of an audio object, etc.

In various embodiments, a designer can produce a large number of distinct audio synthesis configurations that the client computing device 150 stores locally as the audio synthesis configurations 140 (e.g., 140(3)-140(X)). In such instances, the sound synthesis application 160 loads one of the locally stored audio synthesis configurations 140 (e.g., 140(3)) and generates an arrangement and parameters that are specified in the audio synthesis configuration 140(3) to synthesize a particular audio signal. In some embodiments, the audio synthesis configuration 140 can include multiple files. For example, a given audio synthesis configuration 140 can include one file (e.g., a signal flow diagram [.sfd] file) that specifies the audio objects, connections between the audio objects and control signals that are to be used in an arrangement of audio objects, and a separate file (e.g., a set of tuning parameters [.set] files) that specifies the synthesis parameters that configure the respective audio objects.

The client computing device 150 is a device that executes the sound synthesis application 160 and drives the audio output device 170 to generate the sound output 172. In various embodiments, one or more of the client computing device(s) 150, and/or audio output device(s) 170 are included in one or more devices, such as such as an interactive device, soundbar, portable speaker, smart home devices (e.g., digital assistants). In some embodiments, the client computing device 150 can be a consumer product, such as an interactive toy (e.g., a race car that produces a sound). In various embodiments, the client computing device 150 is located in various environments including, without limitation, indoor environments (e.g., living room, bedroom, classroom, etc.), and/or outdoor environments, (e.g., patio, garden, etc.). In some embodiments, the client computing device 150 could be a low-power, limited processing, and/or limited memory device that implements a lightweight processing of incoming data. For example, client computing device 150 could be a Raspberry Pi (e.g., Pi 1®, Pi 2®, Pi 3®, or Pi 4®) that includes a processor such as a digital signal processor, memory (e.g., 1-4 MB RAM), and storage (e.g., a flash storage card). For example, the client computing device 150 could be a development board, such as a Teensey® 4.0 microcontroller development board, or any other board that contains a processor that is used as a digital signal processor, such as an ARM® Cortex M4, or other lightweight computing devices.

The processor 152 be any suitable processor, such as CPU, a GPU, an ASIC, an FPGA, a DSP, and/or any other type of processing unit, or a combination of different processing units, such as a CPU configured to operate in conjunction with a GPU. In general, the processing unit 112 can be any technically feasible hardware unit capable of processing data and/or executing software applications. In some embodiments, the processor 152 could be a low-power processor. In such instances, the digital signal processor performs lightweight computations, including real-time processing of sensor data and/or electrical signals to generate an audio signal.

The memory 154 can include a random-access memory (RAM) module, a flash memory unit, an EEPROM, or any other type of memory unit or combination thereof. The processor 152 is configured to read data from and write data to the memory 154. In various embodiments, the memory 154 includes non-volatile memory, such as optical drives, magnetic drives, flash drives, or other storage. In some embodiments, separate data stores, such as external data stores included in a network (“cloud storage”) can supplement or constitute the memory 154. In some embodiments, the sound synthesis application 160 within the memory 154 can be executed by the processor 152 to implement the overall functionality of the client computing device 150. In various embodiments, an interconnect bus (not shown) connects the processor 152, the memory 154, and any other components of the client computing device 150.

The sound synthesis application 160 executes various techniques to synthesize an audio signal and drive the audio output device 170 to reproduce the synthesized audio signal as the sound output 172. In various embodiments, the sound synthesis application 160 stores one or more audio synthesis configurations 140 (e.g., 140(3)-140(X)) received from external sources, including receiving the audio synthesis configuration 140(1) from the designer computing device 110 and/or receiving the audio synthesis configuration 140(2) stored in the external device 180. For example, the sound synthesis application 160 can cause the client computing device 150 to download the audio synthesis configuration 140(2) from the external device 180 when proximate to the external device 180. In some embodiments, the client computing device 150 downloads and stores multiple audio synthesis configurations from one or more external devices 180 (e.g., 180(1), 180(2), etc.). In various embodiments, the sound synthesis application 160 causes the client computing device 150 to locally store the received audio synthesis configurations 140(1), 140(2) as one or more audio synthesis configurations 140 (e.g., 140(3)-140(X)) within the memory 154.

Additionally or alternatively, the sound synthesis application 160 acquires one or more synthesis characteristic profiles 166 (e.g., 166(2)-166(Y)) that are received from external sources. The sound synthesis application 160 loads the synthesis characteristic profile 166 from the external source for local storage within the memory 154. In such instances, the sound synthesis application 160 can load one or more of the synthesis characteristic profiles 166 and/or the audio synthesis configuration 140 when synthesizing an audio signal. For example, the sound synthesis application 160 can cause the client computing device 150 to download the synthesis characteristic profile 166(1) and/or the audio synthesis configuration 140(2) from the external device 180(1) when proximate to the external device 180(1).

In various embodiments, the sound synthesis application 160 initiates the sound output 172 by producing an arrangement of audio objects 164 in the manner specified in a given audio synthesis configuration 140 and activating the arrangement to synthesize an audio signal. In some embodiments, the audio synthesis application 160 initiates the sound output when the external device 180 becomes proximate to the client computing device 150. In such instances, the client computing device 150 loads the audio synthesis configuration 140 and/or the synthesis characteristic profile 166 into the memory 154. The sound synthesis application 160 then drives the audio output device 170 to reproduce the synthesized audio signal as the sound output 172. In various embodiments, the sound synthesis application 160 modifies a given audio synthesis configuration 140 (e.g., a default audio synthesis configuration 140, etc.) with one or more synthesis characteristic profiles 166. Such modifications change one or more of the synthesized characteristic values used by the arrangement of the audio objects 164 to generate the synthesized audio signal, thereby modifying the configuration of the arrangement of audio objects 164, thereby modifying one or more characteristics of the synthesized audio signal.

The audio synthesis configurations 140 (e.g., 140(3)-140(X)) are locally stored in the memory 154 of the client computing device 150. In various embodiments, the audio synthesis configurations 140 includes a default audio synthesis configuration that the sound synthesis application 160 loads without intervention, and one or more additional audio synthesis configurations that the sound synthesis application 160 selects in response to intervention by the user (e.g., providing an input to select a non-default audio synthesis configuration). In various embodiments, the audio synthesis configurations 140 stored in the client computing device 150 correspond to the audio synthesis configuration 140(1) created by the designer computing device 110, and/or the audio synthesis configuration 140(2) or components (e.g., the signal flow 142(2), etc.) that were stored in other external devices 180 and copied to the client computing device 150.

The characteristic tables 168 and contained within the synthesis characteristic profile 166 and include one or more characteristic tables that include entries mapping a given synthesis characteristic value for a given synthesis characteristic to a specific synthesis parameter setting associated with an audio synthesis configuration 140 and/or an arrangement of audio objects 164 that form part of the audio synthesis configuration. In various embodiments, the sound synthesis application 160 refers to one or more of the characteristic tables 168 to identify one or more specific synthesis parameter setting to use when the arrangement of audio objects 164 synthesizes an audio signal. For example, the client computing device 150 stores separate characteristic tables 168 (e.g., a size characteristic table, a friendliness characteristic table, an energy characteristic table) including entries that map adjective-like descriptors (i.e., the synthesis characteristic values) associated with a given device, including the client computing device 150 and/or the external device 180, with specific synthesis parameter settings. In one example, the size characteristic table stores entries for the size synthesis characteristic, a discrete set of size descriptors (e.g., tiny, small, medium, large, huge, enormous, etc.) as synthesis characteristic values, where each entry maps a specific synthesis characteristic value to a setting for the center frequency of a filter included in the audio synthesis configuration 140. Similarly, the friendliness characteristic table includes entries for friendliness descriptors (e.g., cheerful, happy, delighted, kind, sour, dark, creepy, etc.) as synthesis characteristic values that are mapped to distinct groups of frequency intervals of a band pass filter that are used by the audio synthesis configuration 140.

The audio output device 170 includes a device capable of providing a sound output, such as a loudspeaker. For example, the audio output device 170 could be headphones, ear buds, a wired or wireless speaker system (e.g., one or more loudspeakers, amplifier, etc.), or any other device that generates the sound output 172. In various embodiments, the audio output device 170 can be incorporated into client computing device 150 (e.g., disposed in the body of a form factor including the processor 152 and the audio output device 170), or can be external to the client computing device 150. In various embodiments, the audio output device 170 is implemented using any number of different conventional form factors, such as a single consumer product, discrete loudspeaker devices, personal speakers, body-worn (head, shoulder, arm, etc.) speaker devices, and so forth. In some embodiments, the audio output device 170 can be connected to output devices that additionally provide other forms of outputs, such as display devices that provide visual outputs.

The external device(s) 180 includes one or more synthesis characteristic profiles 166 (e.g., 166(1)) and/or additional audio synthesis configurations 140 (e.g., 140(2)). For example, the external device 180 can be a consumer device that includes a memory (not shown) that stores the synthesis characteristic profile 166(1) and/or audio synthesis configuration 140(2). In some embodiments, the external device 180 can be an object that includes an affixed tag (e.g., barcode, QR code, RFID tag, label, etc.) that includes an encoded version of portions or all of a synthesis characteristic profile 166 and/or an audio synthesis configuration, such as the audio synthesis configuration 140(2), the signal flow 142(2), the tuning parameters 146(2), and/or the control parameters 148(2). In some embodiments, the external device 180 can be a device that includes an instance of the sound synthesis application 160 and/or an instance of the audio output device 170. In such instances, the client computing device 150 communicates with the external device 180 to determine which device is to synthesize an audio signal to produce the sound output 172.

In some embodiments, the external device 180 can store all or portions of multiple synthesis characteristic profiles 166 and/or audio synthesis configurations 140, of which all or a portion are loaded by the client computing device 150 after the client computing device 150 is communicatively coupled to the external device 180. In some embodiments, multiple external devices 180 can be sequentially communicatively coupled to the client computing device 150 for transfer of the audio synthesis configurations 140 or the synthesis characteristic profiles 166 to be stored locally in the memory 154. In various embodiments, the client computing device 150 can acquire the synthesis characteristic profile 166(1) and/or the audio synthesis configuration 140(2) from the external device 180 using various techniques associated with the manner in which the synthesis characteristic profiles 166(1) and/or audio synthesis configuration 140(2) is stored. For example, when the synthesis characteristic profile 166(1) is encoded in a tag, the client computing device 150 can use a camera, or other appropriate sensor, such as an RFID chip reader, to acquire the data from the tag and extract the synthesis characteristic profile 166(1) from the tag. In another example, when the audio synthesis configuration 140(2) is stored in a storage device within the external device 180, the client computing device 150 can establish communications with the external device 180 and download the audio synthesis configuration 140(2). In such instances, the client computing device 150 can limit establishing a communication link with the external device 180 until the sound synthesis application 160 detects that the external device 180 is proximate to the client computing device 150. In various embodiments, the sound synthesis application 160 applies different predetermined thresholds to determine whether a distance to an external device 180 is proximate.

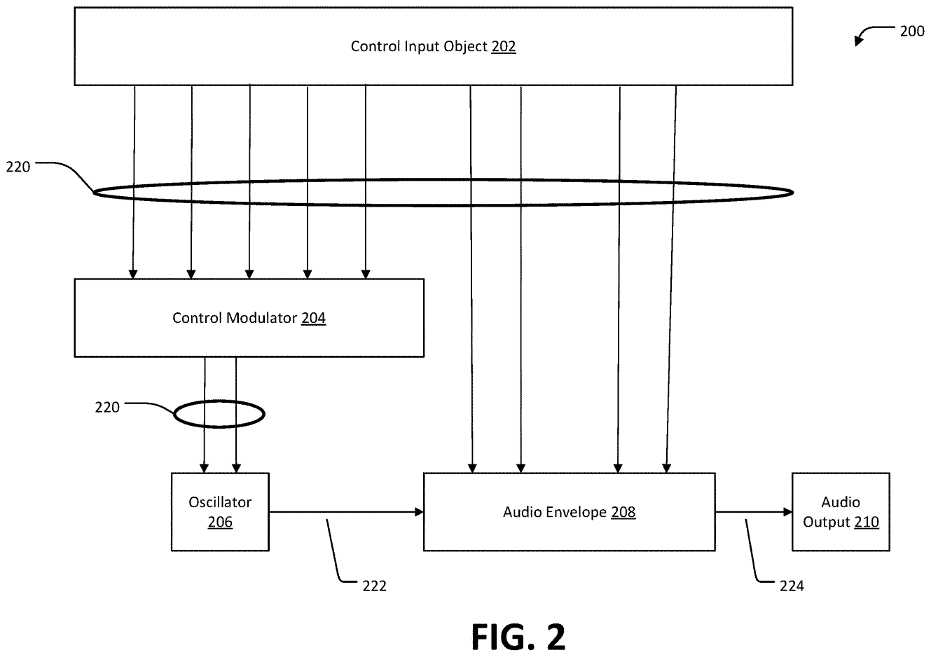

FIG. 2 illustrates a block diagram of an exemplary signal flow 200 executed by the sound synthesis system 100 of FIG. 1, according to various embodiments of the present disclosure. As shown, the signal flow 200 includes, without limitation, a control input object 202, a control modulator 204, an oscillator 206, an audio envelope 208, an audio output module 210, control signals 220, an oscillator audio output signal 222, and a modified oscillator audio output signal 224.

In operation, the sound synthesis application 160 populates the signal flow 200 with a tuning parameter set and a control parameter set to specify an arrangement of audio objects 164 that is to generate a specific synthesized audio signal usable by the audio output device 170 is to output as the sound output 172. In various embodiments, a designer generates the signal flow 200 (e.g., the signal flow 142(1)) using an audio tuning tool 120 to select one or more predefined audio objects 124 from the audio object library 122. In an example, a designer via the audio tuning tool 120, adds various control signal and audio signal connections between the selected audio objects, and specifies how the audio objects 124 are to generate a synthesized audio signal by defining one or more synthesis parameters, including the tuning parameter set and the control parameter set.

The audio objects 202-210 are a subset of predefined audio objects included in the audio object library 122, where the audio objects 124 correspond to the audio objects 164 included in the audio object library 162. The signal flow 200 specifies a specific group of audio objects 202-210 from the audio object library 122 that are to be executed and the routing of control signals 220 to specify an arrangement of audio objects 202-210. The signal flow 200 also specifies audio signals 222, 224 that connect the group of audio objects 202-210. In various embodiments, the signal flow 200 can include other types of audio objects 124. For example, the signal flow 200 can include various noise generators, waveform generators, amplitude controllers, mixers, control signal modulators, frequency equalizers, filters, and so forth to synthesize a synthesized audio signal for output by the audio output device 170.

As shown, the signal flow 200 includes a control input object 202, a control modulator 204, an oscillator 206, an audio envelope 208, and an audio output module 210. When activated, the control input object 202 generates a set of control signals. For example, when loaded on the client computer device 150, the control input object 202 is activated by a manual input from the user (e.g., a button press) and can generate initiation control signals 220 that cause one or more of the other audio objects 206, 208 to operate. The oscillator 206 generates an oscillator audio output signal 222 based on the set of tuning parameters. In various embodiments, the oscillator 206 is also based on control parameters that the oscillator 260 receives from the control input object 202. The audio envelope 208 generates a specific time dependent envelope that shapes the oscillator audio output signal 222 to generate a modified oscillator audio output signal 224. The audio output module 210 converts the modified oscillator signal into a synthesized audio signal for output via the audio output device 170.

In some embodiments, the signal flow 200 can be stored as a netlist that specifies the connections between audio objects. In some embodiments, one or more of the audio objects 202-210 includes a set of tuning parameters (e.g., the tuning parameters 146 included in the audio synthesis configuration 140) that configure the parameters used to operate the respective audio objects 202-210. In some embodiments, the signal flow 200 includes one or more control signals 220 that specify one or more synthesis parameter settings. For example, the signal flow 200 can specify that the control input object 202 outputs a plurality of control signals 220 that specify distinct parameter values, including specific synthesis parameter settings for amplitude, frequency, and phase. In some embodiments, the signal flow can store a set of synthesis characteristic values associated with the respective synthesis parameter settings. For example, a given control signal 220 can provide to the oscillator 206 an amplitude as a synthesis parameter setting. When the sound synthesis application 160 generates the audio synthesis configuration from the signal flow 200, the sound synthesis application 160 retrieve the set of synthesis characteristic values from a characteristic profile to determine the amplitude value to include in the control signal. In some embodiments, a lookup table (not shown) within the signal flow 142(3) receives the control signal 220 whose numerical value is based on the characteristic value from a characteristic profile 166(1), which was read from the external device 180(1). This numerical value quantitatively represents a characteristic value, such as “fast” for the synthesis characteristic, and is associated with the numerical value of “5,” which was stored within the tuning parameters 146(3) associated with the signal flow 142(3). The numerical value of “5” is output from the lookup table as a control signal 220 and is sent to the audio envelope 208 to select a particular envelope stored as table 5.

Additionally or alternatively, in some embodiments, the signal flow 200 includes one or more control signals 220 that specify one or more synthesis parameter values as functions of sensor data. For example, the signal flow 200 can specify that the control input object 202 receives various sensor data values 192 (e.g., temperature, luminance, ambient sound level, etc.) and outputs one or more control signals 220 that modify the synthesis parameter values used by one or more of the modules 204-210. For example, the control modulator 204 outputs two control signals that are sent to the oscillator 206. These control signals can vary in time and control the instantaneous frequency and amplitude of the sine wave that are output by the oscillator 206. The control modulator 204 can receive control signals that indicate specific sensor data values 192 associated with lighting and/or motion and can generate one or more control signals for the oscillator 206 that include the influence of specific sensor data values 192. Alternatively, the control modulator 204 can generate a set of control signals specifying synthesis parameters for the oscillator as a function of the sensor data values 192. For example, the control modulator 204 can generate control signals 220 that specify a specific sine wave according to the formula:

$$Asin ( ω t + b ) \qquad Eq . 1$$

Where A is a function of a sensor value acquired from a light sensor and @ is a function of a sensor data value 192 acquired from a motion sensor (e.g., an accelerometer) and b is a function of a sensor data value 192 received from another sensor 190 (e.g., a microphone). In such instances, the oscillator 206 would receive different control signals 220 from the control modulator 204 based on the sensor data received by the control input object 202 and the frequency and amplitude of the output signal 222 vary with the sensor data values 192. In some embodiments, one or more of the control parameters for the audio envelope 208 can be similarly influenced by the sensor data values 192. In this manner, a designer can use the signal flow 200 to output a large range of synthesized audio signals using the same configuration of audio objects 202-210.

In some embodiments, a signal flow includes some of the synthesis parameters, including a tuning parameter set and control signals. In some embodiments, a signal flow includes all the synthesis parameters; in such instances, the sound synthesis application 160 can load the signal flow in lieu of an audio synthesis configuration 140. In some embodiments, the sensor data value 192 may affect a tuning parameter stored in a tuning parameter set without affecting a control signal. In some embodiments, a sensor data value 192 affects a control signal that is used to select some or all of the tuning parameters for an individual audio object, multiple audio objects, or the entire signal flow 200.

In some embodiments, a range of values included in a characteristic table 168 is mapped to a range of a control signal. For example, a first synthesis characteristic value (e.g., “ecstatic”) corresponds to the maximum desired value for the control signal, and a second synthesis characteristic value (e.g., “apathetic”) corresponds to the minimum desired value for the control signal. In this way, a range of characteristic values can be scaled or mapped to the range of control signals. Additionally or alternatively, in some embodiments, the range of values included in the characteristic table 168 can be mapped to a range of a tuning parameter 146, a state of an audio object 124 (e.g., active or inactive). In this manner, a particular synthesis characteristic profile 166 can alter, bypass, and/or disable specific audio objects 124 included in the signal flow 200.

Sound Synthesis Using Characteristic Values from Multiple Objects

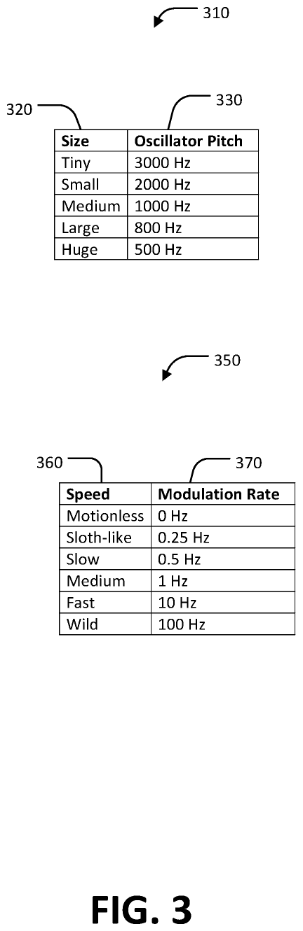

FIG. 3 illustrates a plurality of characteristic tables used by the sound synthesis system 100 of FIG. 1 to generate a composite audio synthesis configuration, according to various embodiments of the present disclosure. As shown, the plurality of characteristic tables includes a size characteristic table 310 and a speed characteristic table 350.

In operation, the client computer device 150 stores characteristic tables 168, including tables 310 and 350, that contain entries mapping a given synthesis characteristic value to a specific synthesis parameter setting associated with an audio synthesis configuration 140. When synthesizing an audio signal, the sound synthesis application 160 identifies one or more synthesis characteristic values listed in the audio synthesis configuration 140 and/or the synthesis characteristic profile 166. The sound synthesis application 160 refers to one or more of characteristic tables 310, 350 to identify a specific synthesis parameter setting corresponding to each of the included synthesis characteristic values. The sound synthesis application 160 then causes the arrangement of audio objects 164 corresponding to the audio synthesis configuration 140 to use the identified synthesis parameter values when synthesizing an audio signal.

The plurality 300 of characteristics tables stored in the client computing device 150 can include various types of synthesis characteristics associated with an audio synthesis configuration 140 and/or a synthesis characteristic profile 166. Examples of synthesis characteristics include size (e.g., tiny, small, medium, large, huge, enormous, etc.), friendliness (e.g., cheerful, happy, delighted, kind, sour, dark, creepy, etc.), intelligence (e.g., stupid, inept, neutral, talented, genius, etc.), and so forth. The plurality of characteristics tables 310, 350 can also include various types of synthesis parameter settings that are mapped to a given synthesis characteristic, such as modulation range, frequency intervals, amplitude envelope ranges, center frequencies, and so forth.

The size characteristic table 310 includes a size column 320 including a finite set of possible synthesis characteristic values that describe the size of the associated device, and an oscillator pitch column 330 that includes corresponding oscillator pitch frequencies as a synthesis parameter setting that an oscillator in a given audio synthesis configuration (e.g., the oscillator 206) is to employ when generating a waveform. When the sound synthesis application 160 retrieves a signal flow 142 that includes a synthesis characteristic value that includes a descriptor for a size of the device, the sound synthesis application 160 refers to the size characteristic table 310 to identify the applicable oscillator pitch to use as a synthesis parameter setting for an oscillator in the audio synthesis configuration.

The speed characteristic table 350 includes a speed column 360 including a finite set of possible synthesis characteristic values that describe the speed of the associated device, and a modulation rate column 370 that includes corresponding modulation rates as a parameter setting that an oscillator in a given audio synthesis configuration is to employ when generating a waveform. When the sound synthesis application 160 retrieves an audio synthesis configuration 140 including a tuning parameter 146 and/or a control parameter 148 that includes a descriptor for a speed of the device, the sound synthesis application 160 refers to the speed characteristic table 350 to identify the applicable modulation rate to use as a synthesis parameter setting for an oscillator identified by the signal flow 142 in the audio synthesis configuration 140.

In one example, the external device 180 is a loudspeaker patterned like a cheetah. In such instances, the external device 180 includes a synthesis characteristic profile 166 that includes “medium” and “fast” as synthesis characteristic values. When the sound synthesis application 160 causes an audio signal to be synthesized based on a combination of an audio synthesis configuration 140(3) and a synthesis characteristic profile 166(1) provided by the external device 180(1), the sound synthesis application 160 refers to the characteristic tables 310, 350 and identifies entries for the synthesis characteristic values that map the respective synthesis characteristic values to the synthesis parameter settings, including an 1000 Hz oscillator pitch and a 10 Hz modulation rate. The sound synthesis application 160 can then drive an arrangement of audio objects 164 corresponding to the audio synthesis configuration 140(3) by configuring tuning parameters 146(4) and/or control parameters 148(3) that include the two specific synthesis parameters.

In one example, the sound synthesis application 160 plays the signal flow 142(2) from the synthesis configuration 140(3). The signal flow 142(2) has one or more of its tuning parameters 146(3), which are stored in a table included in a synthesis characteristic profile 166 stored in the memory 154, modified by the stored synthesis characteristic profile 166(1) read from the external device 180(1), when client computing device 150 is brought in close proximity to external device 180(1). In such instances, the sound synthesis application 160 reads the synthesis characteristic value from the synthesis characteristic profile 166(1), and the synthesis parameter associated with the synthesis characteristic value is selected from local synthesis characteristic profile 166. In this manner, characteristics acquired from the external device 180(1) that is in close proximity to the client computing device 150 modify the audio signal that the client computing device 150 is currently playing. In this manner, characteristics of two audio synthesis configurations blend together to form a new sound.

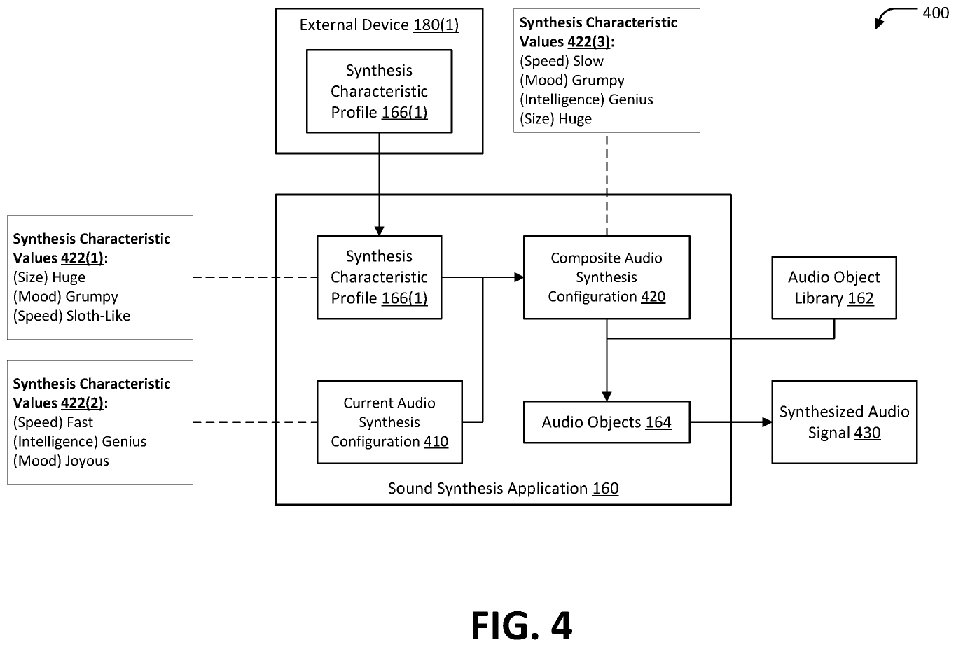

FIG. 4 illustrates a block diagram of the sound synthesis system 100 of FIG. 1 generating a synthesized audio signal 430 based on a composite audio synthesis configuration 420 using a synthesis characteristic profile 166(1) acquired from a proximate external device 180(1), according to various embodiments of the present disclosure. As shown, the system 400 includes, without limitation, the sound synthesis application 160, an external device 180(1), the audio object library 162, and a synthesized audio signal 430. The external device 180(1) includes, without limitation, a synthesis characteristic profile 166(1). The sound synthesis application 160 includes, without limitation, a current audio synthesis configuration 410, the synthesis characteristic profile 166(1), a composite audio synthesis configuration 420 and audio objects 164. The current audio synthesis configuration 410, the synthesis characteristic profile 166(1), and the composite audio synthesis configuration 420, respectively, include synthesis characteristic values 422 (e.g., 422(1), 422(2), 422(3)).

In operation, the sound synthesis application 160 generates a sound using the current sound synthesis configuration 410. The current sound synthesis configuration 410 includes characteristic tables 310, 350 and one or more synthesis characteristic values 422(2). The sound synthesis application 160 acquires the synthesis characteristic profile 166(1) from the external device 180(1). When the sound synthesis application 160 is triggered to generate the synthesized audio signal 430, the sound synthesis application 160 determines which synthesis characteristic values 422(1) from the synthesis characteristic profile 166(1) and synthesis characteristic values 422(2) from the current audio synthesis configuration 410 to select for inclusion in the composite audio synthesis configuration 420. Selecting the respective synthesis characteristic values causes the sound synthesis application 160 to replace and/or blend one or more synthesis characteristic values 422(2) from the current synthesis configuration 410 with one or more synthesis characteristic values 422(1) from the synthesis characteristic profile 166(1).

Upon selecting the synthesis characteristic values 422(3), the sound synthesis application 160 acquires a set of audio objects 164 from the audio object library 122 based on the signal flow 142 included in the composite audio synthesis configuration 420. The sound synthesis application 160 configures the acquired set of audio objects 164 in the manner specified by the composite audio synthesis configuration 420. The sound synthesis application 160 uses the arrangement of audio objects 164 corresponding to the composite audio synthesis configuration 420 to produce the synthesized audio signal 430, where the arrangement uses synthesis parameters corresponding to the synthesis characteristic values 422(3) included in the composite audio synthesis configuration 420. Alternatively, in some embodiments, the sound synthesis application 160 previously selected the set of audio objects to play sounds based on the current synthesis configuration 410. In such instances, the sound synthesis application 160 implements the previously selected audio objects 164 and modifies the output by using the one or more synthesis characteristic values 422(3) of the composite audio synthesis configuration 420, effectively combining the characteristics of the respective audio configurations 410, 166(1).

In some embodiments, the external device 180 can store all or portions of multiple synthesis characteristic profiles 166 and/or audio synthesis configurations 140, of which all or a portion are loaded by the client computing device 150 after the client computing device 150 is communicatively coupled to the external device 180. For example, the client computing device 150 can receive proximity data to determine that the external device 180(1) is proximate to the client computing device 150. In such instances, the sound synthesis application 160 determines whether to acquire the synthesis characteristic profile 166(1) from the external device 180(1). In one example, the sound synthesis application 160 responds to detecting the external device 180(1) by providing a prompt to a user (e.g., output a tone, provide haptic feedback, output a notification light, etc.). The sound synthesis application 160 then receives an authorization input indicating that the sound synthesis application 160 is to acquire the synthesis characteristic profile 166(1) from the external device 180(1). The sound synthesis application 160 acquires the synthesis characteristic profile 166(1) from the external device 180(1). For example, the sound synthesis application 160 can scan a tag in which the synthesis characteristic profile 166(1) is encoded. In another example, the client computing device 150 can establish a wireless communications link with the external device 180(1) when proximate to the external device 180(1).

In various embodiments, the sound synthesis application 160 can store multiple audio synthesis configurations 140 and/or synthesis characteristic profiles 166. In some embodiments, the client computing device 150 can acquire multiple synthesis characteristic profiles 166(1)-166(N) from the designer computing device 110 and/or external devices 180(1)-180 (Y). In such instances, the sound synthesis application 160 can receive an indication to merge two or more sets of synthesis characteristic values 422 (e.g., 422(1) and 422(2)) that are included in the current audio synthesis configuration 410 and the one or more synthesis characteristic profiles 166 to generate a composite audio synthesis configuration 420 that exhibits characteristics from both sources. When the sound synthesis application 160 receives an indication to output an audio output, the sound synthesis application 160 uses the composite audio synthesis configuration 420 for configuring a set of audio objects 164 to generate a synthesized audio signal 430.

In some embodiments, the user provides an indication to select specific synthesis characteristic values or merge specific synthesis characteristic values from the current audio synthesis configuration 410 or the synthesis characteristic profile 166(1). In such instances, the sound synthesis application 160 responds by performing various techniques to generate the synthesis characteristic values 422(3) for the composite audio synthesis configuration 420. For example, the user can select one or more of the synthesis characteristic values 422(1)-422(2) from a visual menu.

In another example, the user can provide a speech input that the client computing device 150 processes as indicating a selection of specific synthesis characteristic value, or a preference for a specific set of synthesis characteristic values (e.g., “I want the siren to sound big, like that elephant,” or “I want to that to include the honey badger from the honey badger speaker!”). In such instances, the sound synthesis application 160 responds to the user indication by selecting applicable synthesis characteristic values from the synthesis characteristic values 422(1)-422(2). The sound synthesis application 160 then responds to subsequent user inputs indicating that the sound synthesis application 160 is to output a sound by arranging the audio objects 164 in the manner specified by composite audio synthesis configuration 420 and uses the arrangement of audio objects 164 to generate the synthesized audio signal 430.

In another example, the sound synthesis application 160 can incorporate an audio synthesis configuration 140(2) from an external device 180(1) that remains in close proximity to the client computing device 150 for an extended period. In such instances, the sound synthesis application 160 uses characteristics from the audio synthesis application 140(2) to form a majority of the synthesis characteristic values 422(3) of the composite audio synthesis configuration 420. Additionally or alternatively, the sound synthesis application 160 can acquire one or more synthesis characteristic values 422 from additional external devices 180(2)-180(X) that are proximate to the client computing device 150 for a shorter durations than the external device 180(1). In such instances, the synthesis characteristic values 422 from the multiple additional external devices 180(2)-180(X) can modify portions of the composite audio synthesis configuration 420.

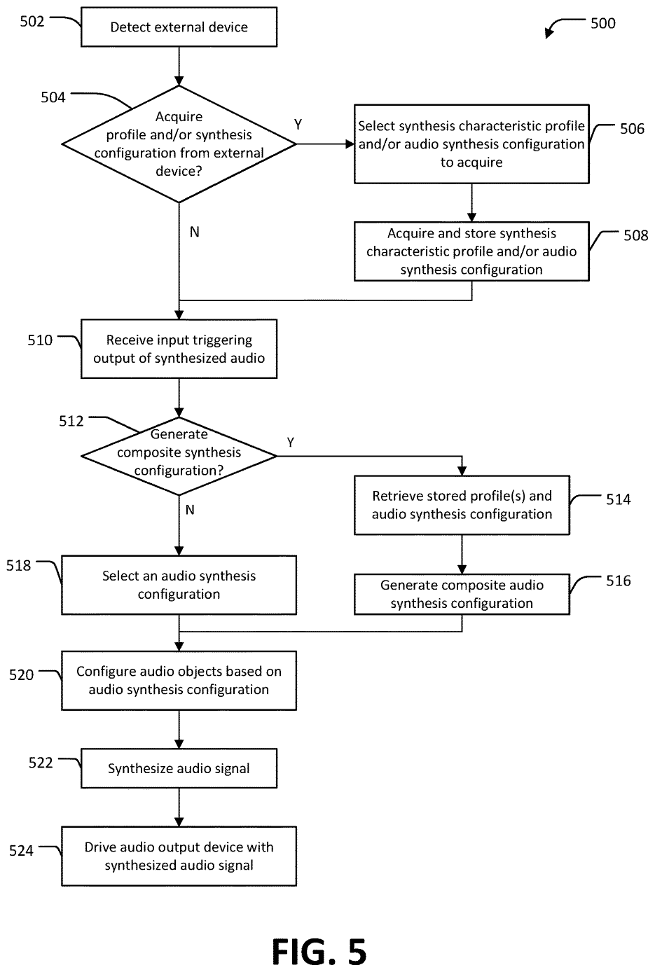

FIG. 5 sets forth a flow diagram of method steps for synthesizing an audio signal for output by an audio output device, according to various embodiments of the present disclosure. Although the method steps are described with reference to the systems of FIGS. 1-4, persons skilled in the art will understand that any system configured to implement the method steps, in any order, falls within the scope of the present disclosure.

As shown, method 500 begins at step 502, where the sound synthesis application 160 detects an external device 180. In various embodiments, the sound synthesis application 160 performs various techniques detect the external device 180. For example, the client computing device 150 can receive proximity data to determine that the external device 180 is proximate to the client computing device 150.

At step 504, the sound synthesis application 160 determines whether to acquire the synthesis characteristic profile 166 and/or the audio synthesis configuration 140 included in the external device 180. In various embodiments, the sound synthesis application 160 determines whether the client computing device 150 is to acquire any synthesis characteristic profiles 166 and/or audio synthesis configurations 140 that are stored in the external device 180. For example, the sound synthesis application 160 can respond to detecting the external device 180 by providing a prompt to a user (e.g., output a tone, provide haptic feedback, output a notification light, etc.). The sound synthesis application 160 can then determine whether the client computing device 150 received an authorization input indicating that the sound synthesis application 160 is to acquire at least one of the synthesis characteristic profiles 166 and/or the audio synthesis configurations 140 from the external device 180. When the sound synthesis application 160 determines that the client computing device 150 is to acquire at least one of the synthesis characteristic profiles 166 and/or the audio synthesis configurations 140, the sound synthesis application 160 proceeds to step 506. Otherwise, the sound synthesis application 160 determines that the client computing device 150 is not to acquire any of the synthesis characteristic profiles 166 or the audio synthesis configurations 140 and uses an audio synthesis configuration 140 already stored in client computing device 150 and proceeds to step 510.

At step 506, the sound synthesis application 160 selects one or more synthesis characteristic profiles 166 and/or audio synthesis configurations 140 to acquire. In various embodiments, the sound synthesis application 160 identifies one or more synthesis characteristic profiles 166 and/or audio synthesis configurations 140 stored in the external device 180 for download. In some embodiments, the external device 180 stores a single synthesis characteristic profile 166 or audio synthesis configuration 140. In such instances, the sound synthesis application 160 responds to the determination at step 504 by downloading the single synthesis characteristic profile 166 or the audio synthesis configuration 140. In some embodiments, the external device 180 includes multiple synthesis characteristic profiles 166 and/or audio synthesis configuration 140. In some embodiments, the sound synthesis application 160 prompts the user to select from the available synthesis characteristic profiles 166 and/or audio synthesis configuration 140 stored in the external device 180. Alternatively, the sound synthesis application 160 automatically performs a specific action, such as downloading each synthesis characteristic profile 166 and/or audio synthesis configuration 140 or downloading a default synthesis characteristic profile 166 and/or audio synthesis configuration 140 identified by the external device 180.

At step 508, the sound synthesis application 160 acquires and stores the selected synthesis characteristic profiles 166 and/or audio synthesis configurations 140. In various embodiments, the sound synthesis application 160 acquires the selected synthesis characteristic profile 166 and/or audio synthesis configuration 140 from the external device 180 based on how the external device 180 stores the synthesis characteristic profile 166 and/or the audio synthesis configuration 140. For example, the sound synthesis application 160 can scan a tag affixed to the external device 180, where the tag stores one or more encoded synthesis characteristic profiles 166 and/or audio synthesis configurations 140. In another example, the client computing device 150 can establish a wireless communications link with the external device 180 when proximate to the external device 180. The sound synthesis application 160 stores the selected synthesis characteristic profiles 166 and/or audio synthesis configurations 140 in the local memory 154.

At step 510, the sound synthesis application 160 receives an input triggering an output of synthesized audio. In various embodiments, the sound synthesis application 160 can receive an input indicating that the sound synthesis application 160 is to produce a synthesized audio signal 430. In some embodiments, the input is a manual input from a user. For example, the user can press a button or provide an audio command that indicates that the client computing device 150 executing the sound synthesis application 160 is to produce a sound output 172 corresponding to the synthesized audio signal 430. Alternatively, in some embodiments, the sound synthesis application 160 detects a trigger based on acquired sensor data. The sound synthesis application 160 receives sensor data and determines that the sensor data indicates that the sound synthesis application 160 to produce a sound output 172. For example, the sound synthesis application 160 can receive sensor data indicating proximity to the external device 180. In such instances, the sound synthesis application 160 can determine that the sensor data indicates that the client computing device 150 is to produce the sound output 172. In some embodiments, the sound synthesis application 160 can loop the sound output repeatedly until an additional signal (e.g., a sensor input indicating “stop”) is received by the client computing device 150.

At step 512, the sound synthesis application 160 determines whether to generate a composite audio synthesis configuration for synthesis. In various embodiments, the client computing device 150 stores the one or more audio synthesis configurations 140 to synthesize an audio signal 430. The client computing device 150 also stores one or more synthesis characteristic profiles 166 that the sound synthesis application 160 uses to modify a given audio synthesis configuration 140 to generate a composite audio synthesis configuration 420. In some embodiments, the sound synthesis application 160 receives an input that indicates that the sound synthesis application 160 is to augment the audio synthesis configuration 140 with one or more of the synthesis characteristic profiles 166. For example, upon the client computing device 150 becoming proximate to an external device 180 and downloading the synthesis characteristic profile 166 stored in the external device 180, the sound synthesis application 160 can prompt the user to indicate whether the sound synthesis application 160 is to incorporate the recently downloaded synthesis characteristic profile 166 with a specific audio synthesis configuration 140 (e.g., the current audio synthesis configuration 410). In some embodiments, the client computing device 150 previously downloaded the synthesis characteristic profile 166 and/or the audio synthesis configuration 140 stored in external device 180. In such instances, when the sound synthesis application 160 detects the external device 180 as proximate to the client computing device 150, the synthesis characteristic profile 166 and/or the audio synthesis configuration 140 is loaded from the memory 154 rather than from the external device 180. When the sound synthesis application 160 determines that the composite audio synthesis configuration 420 is to be generated, the sound synthesis application proceeds to step 514. Otherwise, the sound synthesis application 160 determines that the composite audio synthesis configuration 420 is not to be generated and proceeds to step 518.

At step 514, the sound synthesis application 160 retrieves a signal flow 142 and one or more of the synthesis characteristic profiles 166 stored in the client computing device 150. In some embodiments, the sound synthesis application 160 receives an indication to augment the current audio synthesis configuration 410 with one or more of the synthesis characteristic profiles 166 stored in the client computing device 150 or the external device 180. In such instances, the sound synthesis application 160 retrieves the current audio synthesis configuration 410 and the selected synthesis characteristic profiles 166 from the memory 154. In some embodiments, the user selects a specific audio synthesis configuration 140 to modify. In such instances, the sound synthesis application 160 retrieves the selected audio synthesis configuration 140 in lieu of the current audio synthesis configuration 410.

At step 516, the sound synthesis application 160 generates the composite audio synthesis configuration 420. In various embodiments, the sound synthesis application 160 performs various techniques to generate the composite audio synthesis configuration 420 from the retrieved audio synthesis configuration by including the synthesis characteristic values 422 for the composite audio synthesis configuration 420 that are based on synthesis characteristic values 422 from the retrieved synthesis characteristic profile(s) 166 and the retrieved audio synthesis configuration, respectively. In some embodiments, the user provides an indication to select specific synthesis characteristic values from the audio synthesis configuration 140 or the synthesis characteristic profile(s) 166, or merge specific synthesis characteristic values from the audio synthesis configuration and the synthesis characteristic profile(s) 166. In such instances, the sound synthesis application 160 selects and/or merges applicable synthesis characteristic values from the synthesis characteristic values 422 to generate the synthesis characteristic values 422 that are included in the composite audio synthesis configuration 420. In some embodiments, the synthesis characteristic values 422 are loaded from the external device 180. In such instances, the sound synthesis application 160 modifies corresponding synthesis parameters of the current audio synthesis configuration 410, thereby forming a composite audio synthesis configuration 420.

At step 518, the sound synthesis application 160 selects an audio synthesis configuration 140. In various embodiments, the sound synthesis application 160 receives an indication to select an audio synthesis configuration 140 to synthesize without alteration. In such instances, the sound synthesis application 160 retrieves a specific audio synthesis configuration 140 from the memory 154 for synthesis without modifying the characteristic values of the retrieved audio synthesis configuration 140. In some embodiments, the user does not provide an indication of a specific audio synthesis configuration 140 to retrieve. In such instances, the sound synthesis application 160 retrieves the current audio synthesis configuration 410 for synthesis. Alternatively, the user provides an indication of a specific audio synthesis configuration 140 for synthesis. In such instances, the sound synthesis application 160 retrieves the identified audio synthesis configuration 140 for synthesis.

At step 520, the sound synthesis application 160 configures a set of audio objects based on the audio synthesis configuration. In various embodiments, the sound synthesis application 160 loads information from the audio synthesis configuration selected for synthesis (e.g., the selected audio synthesis configuration 140 or the composite audio synthesis configuration 420) and configures a set of audio objects 164 retrieved from the audio object library 162 stored in the client computing device 150 into an arrangement corresponding to the audio synthesis configuration. In various embodiments, the audio synthesis configuration includes a signal flow comprising a netlist that specifies a group of audio objects 164 that are defined in the audio object library 162, as well as control signals 220 and/or output signals 222, 224 that connect the respective audio objects 164 included in the group of audio objects 164. In various embodiments, the selected audio synthesis configuration includes a set of synthesis characteristic values 422 and/or synthesis parameters that modify the operation of the respective audio objects 164 in the arrangement. In such instances, the sound synthesis application 160 modifies the group of audio objects using the set of synthesis parameters included in the selected audio synthesis configuration and/or the synthesis parameter settings corresponding to the synthesis characteristic values 422. In some embodiments, the sound synthesis application 160 updates one or more control signals 220 with the synthesis parameter settings corresponding to the synthesis characteristic values.

At step 522, the sound synthesis application 160 synthesizes the audio signal 430. In various embodiments, the sound synthesis application 160 drives the arrangement of audio objects to generate a synthesized audio signal 430. In some embodiments, the synthesized audio signal 430 is based on varying combinations of the audio synthesis configuration and varying synthesis characteristic profiles 166. In such instances, the sound synthesis application 160 continually processes the synthesis characteristic profiles 166 and modifies the synthesized audio signal 430 based on updated composite audio synthesis configurations 420 generated from the various synthesis characteristic profiles 166. For example, a first composite audio synthesis configuration 420 includes a first synthesis characteristic value 422 (e.g., “sleepy”) associated with an amplitude of a waveform generated by the oscillator 206. In such instances, the sound synthesis application 160 can continually receive indications to mix the audio synthesis configuration with different synthesis characteristic profiles 166 and update the synthesis characteristic values based on the contents of the different synthesis characteristic profiles 166 (e.g., a second synthesis characteristic profile 166(2) including an “elated” synthesis characteristic value 422, a third synthesis characteristic profile 166(3) including, a “fierce” synthesis characteristic value 422, etc.). For example, the oscillator 206 can modify the periodic audio output signal 222 based on the amplitude values that the sound synthesis application 160 retrieves from the applicable characteristic table 168, causing the synthesized audio signal 430 to change as the device that provides the synthesis characteristic profile 166 used to augment the current audio synthesis configuration 410 changes.

At step 524, the sound synthesis application 160 drives the audio output device 170 with the synthesized audio signal. In various embodiments, the sound synthesis application 160 transmits the synthesized audio signal 430 to the audio output device 170 for reproduction. In some embodiments, the client computing device 150 continually transmits sequential samples and/or sequential blocks of audio samples to the audio output device 170 as the audio synthesis configuration synthesizes the audio signal. In some embodiments, the sound synthesis application 160 drives the audio output device 170 to reproduce all of the sequential blocks of audio samples in the synthesized audio signal 430 a single time. Alternatively, in some embodiments, the sound synthesis application 160 drives the audio output device 170 to repeatedly reproduce the synthesized audio signal 430 until the sound synthesis application 160 receives an input from the user indicating that the client computing device 150 is to stop producing the synthesized audio signal. In some embodiments, the sound synthesis application 160 can repeatedly execute code forming the audio synthesis configuration 140 to continually synthesize and transmit the synthesized audio signal 430 to the output device 170.

In sum, a client computing device executing a sound synthesis application receives an audio synthesis configuration specifying the audio objects and control signals that are to be used to synthesize an audio signal. The audio synthesis configuration includes a signal flow that specifies which audio objects from an audio object library are to be used and the tuning parameters and control signals that specify synthesis parameters for the respective audio objects. Based on the audio synthesis configuration, the client computing device generates an arrangement of audio objects and connections between the audio objects in the manner specified in the audio synthesis configuration. The sound synthesis application uses the arrangement of audio objects to synthesize the audio signal in real time based on combining the signal flow with synthesis characteristic values associated with synthesis characteristic profiles or audio synthesis configurations from other objects. Each synthesis characteristic value is associated with a synthesis parameter setting used by a given arrangement of audio objects to generate a synthesized audio signal. The sound synthesis application augments a default audio synthesis configuration by retrieving a set of synthesis characteristic values associated with one or more other objects. In such instances, the sound synthesis application uses one or more of the synthesis characteristic values to modify the default audio synthesis configuration to generate a composite audio synthesis configuration that merges the synthesis characteristic values of the two or more objects.

At least one technological advantage of the sound synthesis application relative to the prior art is that, with the disclosed techniques, the sound synthesis application can generate a large variety of sounds in real time using a small microprocessor and memory. Another advantage is that the sound synthesis application is able to alter the generated sound based on sound synthesis parameters attributed to nearby devices and customize the sound output based on the presence of nearby devices. Generating sounds based on the presence of nearby devices enables the sound synthesis application to generate multiple sound outputs using a limited library of data stored in the memory. Such techniques increase the variety of sounds that the device can produce, increasing the usefulness of the device producing the synthesized sounds. These technical advantages provide one or more technological advancements over prior art approaches.
1. In various embodiments, a computer-implemented method comprises generating, based on an audio synthesis configuration, an arrangement including at least one audio object to synthesize an audio signal, retrieving a synthesis characteristic profile acquired from an external device, the synthesis characteristic profile indicating one or more respective characteristic values for one or more synthesis characteristics, identifying one or more synthesis parameter settings based on the one or more respective characteristic values, modifying the arrangement based on the identified one or more synthesis parameter settings to generate a modified arrangement, activating the modified arrangement to generate a synthesized audio signal, and outputting, using an audio output device, an audio reproduction of the synthesized audio signal.
2. The computer-implemented method of clause 1, where the synthesis characteristic profile includes a first synthesis characteristic value for a first synthesis characteristic of the one or more synthesis characteristics that corresponds to a first synthesis parameter setting, and a second synthesis characteristic value for a second synthesis characteristic of the one or more synthesis characteristics that corresponds to a second synthesis parameter setting.
3. The computer-implemented method of clause 1 or 2, where identifying the one or more synthesis parameter settings comprises, for each of the one or more respective characteristic values, using a lookup table mapping one or more discrete synthesis characteristic values to a synthesis parameter setting, identifying an entry in the lookup table including the respective characteristic value, and retrieving from the entry a corresponding synthesis parameter setting as an identified synthesis parameter setting.
4. The computer-implemented method of any of clauses 1-3, where the lookup table includes entries for at least a first synthesis characteristic and a second synthesis characteristic.
5. The computer-implemented method of any of clauses 1-4, further comprising detecting the external device, and in response to detecting the external device, acquiring the synthesis characteristic profile from the external device.
6. The computer-implemented method of any of clauses 1-5, where retrieving the synthesis characteristic profile comprises receiving the synthesis characteristic profile from a storage device of the external device, or decoding a tag of the external device that includes an encoded version of the synthesis characteristic profile.
7. The computer-implemented method of any of clauses 1-6, further comprising receiving, from a user, a selection of the synthesis characteristic profile from a plurality of synthesis characteristic profiles.
8. The computer-implemented method of any of clauses 1-7, further comprising retrieving a second synthesis characteristic profile acquired from a second external device, the second synthesis characteristic profile indicating respective second characteristic values for at least one of the one or more synthesis characteristics, and identifying one or more second synthesis parameter settings based on the respective second characteristic values, where modifying the arrangement is further based on the second synthesis parameter settings.
9. The computer-implemented method of any of clauses 1-8, further comprising receiving, a selection of a second synthesis characteristic profile, and in response to receiving the selection, retrieving the second synthesis characteristic profile, the second synthesis characteristic profile indicating respective second characteristic values for at least one of the one or more synthesis characteristics, identifying one or more second synthesis parameter settings based on the respective second characteristic values, modifying the arrangement based on the identified one or more second synthesis parameter settings to generate a second modified arrangement, activating the second modified arrangement to generate a second synthesized audio signal, and outputting, using the audio output device, a second audio reproduction of the second synthesized audio signal.
10. The computer-implemented method of any of clauses 1-9, further comprising detecting the external device, and in response to detecting the external device, acquiring the audio synthesis configuration from the external device.
11. In various embodiments, one or more non-transitory computer-readable media store instructions that, when executed by one or more processors, cause the one or more processors to perform the steps of generating, based on an audio synthesis configuration, an arrangement including at least one audio object to synthesize an audio signal, retrieving a synthesis characteristic profile acquired from an external device, the synthesis characteristic profile indicating one or more respective characteristic values for one or more synthesis characteristics, identifying one or more synthesis parameter settings based on the one or more respective characteristic values, modifying the arrangement based on the identified one or more synthesis parameter settings to generate a modified arrangement, activating the modified arrangement to generate a synthesized audio signal, and outputting, using an audio output device, an audio reproduction of the synthesized audio signal.
12. The one or more non-transitory computer-readable media of clause 11, where the synthesis characteristic profile includes a first synthesis characteristic value for a first synthesis characteristic of the one or more synthesis characteristics that corresponds to a first synthesis parameter setting, and a second synthesis characteristic value for a second synthesis characteristic of the one or more synthesis characteristics that corresponds to a second synthesis parameter setting.
13. The one or more non-transitory computer-readable media of clause 11 or 12, where the steps further comprise receiving, a selection of a second synthesis characteristic profile, and in response to receiving the selection, retrieving the second synthesis characteristic profile, the second synthesis characteristic profile indicating respective second characteristic values for at least one of the one or more synthesis characteristics, identifying one or more second synthesis parameter settings based on the respective second characteristic values, modifying the arrangement based on the identified one or more second synthesis parameter settings to generate a second modified arrangement, activating the second modified arrangement to generate a second synthesized audio signal, and outputting, using the audio output device, a second audio reproduction of the second synthesized audio signal.
14. The one or more non-transitory computer-readable media of any of clauses 11-13, where identifying the one or more synthesis parameter settings comprises for each of the one or more respective characteristic values, using a lookup table mapping one or more discrete synthesis characteristic values to a synthesis parameter setting, identifying an entry in the lookup table including the respective characteristic value, and retrieving from the entry a corresponding synthesis parameter setting as an identified synthesis parameter setting.
15. The one or more non-transitory computer-readable media of any of clauses 11- 14, where the steps further comprise receiving an input from a user to output the audio reproduction, and retrieving the audio synthesis configuration from a local storage device.
16. The one or more non-transitory computer-readable media of any of clauses 11-15, where the steps further comprise receiving an input from a user selecting the synthesis characteristic profile from a set of stored synthesis characteristic profiles, wherein the input indicates outputting a sound corresponding to the selected synthesis characteristic profile.
17. The one or more non-transitory computer-readable media of any of clauses 11-16, where the steps further comprise detecting the external device, and in response to detecting the external device, acquiring the synthesis characteristic profile from the external device, where the external device stores the synthesis characteristic profile in a storage device or includes a tag that includes an encoded version of the synthesis characteristic profile.
18. In various embodiments, a system outputs a synthesized audio signal, the system comprising a sensor device that detects an external device, a memory storing instructions, and one or more processors coupled to the memory configured to execute the instructions to generate, based on an audio synthesis configuration, an arrangement including at least one audio object to synthesize an audio signal, retrieve a synthesis characteristic profile acquired from an external device, the synthesis characteristic profile indicating one or more respective characteristic values for one or more synthesis characteristics, identify one or more synthesis parameter settings based on the one or more respective characteristic values, modify the arrangement based on the identified one or more synthesis parameter settings to generate a modified arrangement, activate the modified arrangement to generate a synthesized audio signal, and output, using an audio output device, an audio reproduction of the synthesized audio signal.
19. The system of clause 18, where the memory stores a lookup table, and the one or more processors are further configured to execute the instructions to for each of the one or more respective characteristic values, use a lookup table mapping one or more discrete synthesis characteristic values to a synthesis parameter setting, identify an entry in the lookup table including the respective characteristic value, and retrieve from the entry a corresponding synthesis parameter setting as an identified synthesis parameter setting.
20. The system of clause 18 or 19, where the one or more processors include a low-power digital signal processor that synthesizes the audio signal.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method comprising:
generating, based on an audio synthesis configuration, an arrangement including at least one audio object to synthesize an audio signal;
retrieving a synthesis characteristic profile acquired from an external device, the synthesis characteristic profile indicating one or more respective characteristic values for one or more synthesis characteristics;
identifying one or more synthesis parameter settings based on the one or more respective characteristic values;
modifying the arrangement based on the identified one or more synthesis parameter settings to generate a modified arrangement;
activating the modified arrangement to generate a synthesized audio signal; and
outputting, using an audio output device, an audio reproduction of the synthesized audio signal.

2. The computer-implemented method of claim 1, wherein the synthesis characteristic profile includes:
a first synthesis characteristic value for a first synthesis characteristic of the one or more synthesis characteristics that corresponds to a first synthesis parameter setting; and
a second synthesis characteristic value for a second synthesis characteristic of the one or more synthesis characteristics that corresponds to a second synthesis parameter setting.

3. The computer-implemented method of claim 1, wherein identifying the one or more synthesis parameter settings comprises:
for each of the one or more respective characteristic values, using a lookup table mapping one or more discrete synthesis characteristic values to a synthesis parameter setting;
identifying an entry in the lookup table including the respective characteristic value; and
retrieving from the entry a corresponding synthesis parameter setting as an identified synthesis parameter setting.

4. The computer-implemented method of claim 3, wherein the lookup table includes entries for at least a first synthesis characteristic and a second synthesis characteristic.

5. The computer-implemented method of claim 1, further comprising:
detecting the external device; and
in response to detecting the external device, acquiring the synthesis characteristic profile from the external device.

6. The computer-implemented method of claim 5, wherein retrieving the synthesis characteristic profile comprises:
receiving the synthesis characteristic profile from a storage device of the external device; or
decoding a tag of the external device that includes an encoded version of the synthesis characteristic profile.

7. The computer-implemented method of claim 1, further comprising:
receiving, from a user, a selection of the synthesis characteristic profile from a plurality of synthesis characteristic profiles.

8. The computer-implemented method of claim 1, further comprising:
retrieving a second synthesis characteristic profile acquired from a second external device, the second synthesis characteristic profile indicating respective second characteristic values for at least one of the one or more synthesis characteristics; and
identifying one or more second synthesis parameter settings based on the respective second characteristic values,
wherein modifying the arrangement is further based on the second synthesis parameter settings.

9. The computer-implemented method of claim 1, further comprising:
receiving, a selection of a second synthesis characteristic profile; and
in response to receiving the selection:
retrieving the second synthesis characteristic profile, the second synthesis characteristic profile indicating respective second characteristic values for at least one of the one or more synthesis characteristics;
identifying one or more second synthesis parameter settings based on the respective second characteristic values,
modifying the arrangement based on the identified one or more second synthesis parameter settings to generate a second modified arrangement;
activating the second modified arrangement to generate a second synthesized audio signal; and
outputting, using the audio output device, a second audio reproduction of the second synthesized audio signal.

10. The computer-implemented method of claim 1, further comprising:
detecting the external device; and
in response to detecting the external device, acquiring the audio synthesis configuration from the external device.

11. One or more non-transitory computer-readable media storing instructions that, when executed by one or more processors, cause the one or more processors to perform the steps of:
generating, based on an audio synthesis configuration, an arrangement including at least one audio object to synthesize an audio signal;
retrieving a synthesis characteristic profile acquired from an external device, the synthesis characteristic profile indicating one or more respective characteristic values for one or more synthesis characteristics;
identifying one or more synthesis parameter settings based on the one or more respective characteristic values;
modifying the arrangement based on the identified one or more synthesis parameter settings to generate a modified arrangement;
activating the modified arrangement to generate a synthesized audio signal; and
outputting, using an audio output device, an audio reproduction of the synthesized audio signal.

12. The one or more non-transitory computer-readable media of claim 11, wherein the synthesis characteristic profile includes:
a first synthesis characteristic value for a first synthesis characteristic of the one or more synthesis characteristics that corresponds to a first synthesis parameter setting; and
a second synthesis characteristic value for a second synthesis characteristic of the one or more synthesis characteristics that corresponds to a second synthesis parameter setting.

13. The one or more non-transitory computer-readable media of claim 11, wherein the steps further comprise:
receiving, a selection of a second synthesis characteristic profile; and
in response to receiving the selection:
retrieving the second synthesis characteristic profile, the second synthesis characteristic profile indicating respective second characteristic values for at least one of the one or more synthesis characteristics;
identifying one or more second synthesis parameter settings based on the respective second characteristic values,
modifying the arrangement based on the identified one or more second synthesis parameter settings to generate a second modified arrangement;
activating the second modified arrangement to generate a second synthesized audio signal; and
outputting, using the audio output device, a second audio reproduction of the second synthesized audio signal.

14. The one or more non-transitory computer-readable media of claim 11, wherein identifying the one or more synthesis parameter settings comprises:
for each of the one or more respective characteristic values, using a lookup table mapping one or more discrete synthesis characteristic values to a synthesis parameter setting;
identifying an entry in the lookup table including the respective characteristic value; and
retrieving from the entry a corresponding synthesis parameter setting as an identified synthesis parameter setting.

15. The one or more non-transitory computer-readable media of claim 11, wherein the steps further comprise:
receiving an input from a user to output the audio reproduction; and
retrieving the audio synthesis configuration from a local storage device.

16. The one or more non-transitory computer-readable media of claim 11, wherein the steps further comprise receiving an input from a user selecting the synthesis characteristic profile from a set of stored synthesis characteristic profiles, wherein the input indicates outputting a sound corresponding to the selected synthesis characteristic profile.

17. The one or more non-transitory computer-readable media of claim 11, wherein the steps further comprise:
detecting the external device; and
in response to detecting the external device, acquiring the synthesis characteristic profile from the external device,
wherein the external device stores the synthesis characteristic profile in a storage device or includes a tag that includes an encoded version of the synthesis characteristic profile.

18. A system that outputs a synthesized audio signal, the system comprising:
a sensor device that detects an external device;
a memory storing instructions; and
one or more processors coupled to the memory configured to execute the instructions to:
generate, based on an audio synthesis configuration, an arrangement including at least one audio object to synthesize an audio signal;
retrieve a synthesis characteristic profile acquired from an external device, the synthesis characteristic profile indicating one or more respective characteristic values for one or more synthesis characteristics;
identify one or more synthesis parameter settings based on the one or more respective characteristic values;
modify the arrangement based on the identified one or more synthesis parameter settings to generate a modified arrangement;
activate the modified arrangement to generate a synthesized audio signal; and
output, using an audio output device, an audio reproduction of the synthesized audio signal.

19. The system of claim 18, wherein the memory stores a lookup table, and the one or more processors are further configured to execute the instructions to:
for each of the one or more respective characteristic values, use a lookup table mapping one or more discrete synthesis characteristic values to a synthesis parameter setting;
identify an entry in the lookup table including the respective characteristic value; and
retrieve from the entry a corresponding synthesis parameter setting as an identified synthesis parameter setting.

20. The system of claim 18, wherein the one or more processors include a low-power digital signal processor that synthesizes the audio signal.
